(19) United States
(12) Patent Application Publication
(10) Pub. No.: US 2024/0416732 A1
(43) Pub. Date: Dec. 19, 2024

(54) soft folding car cover

(71) Applicant: ZHEJIANG SURPASS AUTO PARTS CO., LTD., Wenzhou City (CN)

(72) Inventors: Shiqi ZHENG, Wenzhou City (CN); Dongdong WANG, Wenzhou City (CN); Yien WANG, Wenzhou City (CN); Yi LIN, Wenzhou City (CN); Lei LIN, Wenzhou City (CN)

(21) Appl. No.: 18/506,975

(22) Filed: Nov. 10, 2023

(30) Foreign Application Priority Data
Jun. 14, 2023 (CN) 202310706066.1

(51) Int. Cl. B60J 7/06; B60J 7/185

(52) U.S. Cl. CPC B60J 7/061; B60J 7/185

(57) ABSTRACT

The present invention discloses a soft folding car cover, which includes a longitudinal support structure and a transverse support structure connected to the longitudinal support structure, the longitudinal support structure and transverse support structure are used to support the leather, by forming a cover skeleton with a longitudinal support structure and a transverse support structure, and then attaching a waterproof leather directly to the cover skeleton, the invention can minimise the weight as well as the cost of the cover, while providing a waterproof effect.

### TECHNICAL FIELD

This invention is relevant to automotive spare parts, especially a soft folding car cover.

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using the cover to cover the goods inside the hopper to prevent the goods inside the hopper from getting wet in the rain.

Most of the current covers are frame structures, with a cover plate connected between each frame and then a support beam on the lower side of the cover plate, thus ensuring the waterproof effect of the cover. However, the above structure is not only too complicated, but also consumes more material, which not only does not save material, but also makes the processed car cover heavy and inconvenient to use.

### ABOUT THE INVENTION

The purpose of the present invention is to provide a soft folding car cover, by improving the car cover as a whole, eliminating the original cover structure, forming a car cover skeleton through the horizontal and longitudinal support structure, and then directly attaching the waterproof leather, so that the car cover not only has a good waterproof effect, but also greatly reduce the production cost, making the car cover light in weight and convenient to use.

In order to solve the above problems of the existing technology, the technical solution adopted in the invention is as follows:

A soft cover folding car cover, includes a longitudinal support structure and a transverse support structure connected to the longitudinal support structure, the longitudinal support structure and transverse support structure are used to support the leather, by forming a skeleton of the car cover through the longitudinal support structure and the transverse support structure, and then directly connecting the waterproof leather to the skeleton of the car cover, it can reduce the weight of the car cover as much as possible and lower the cost of the car cover while playing a waterproof effect, the longitudinal support structure includes two side rail assemblies, each side rail assembly includes a plurality of side rails, two adjacent side rails are connected to each other by a rotating shaft joint assembly, the rotating shaft joint assembly is either a first rotating shaft joint assembly or a second rotating shaft joint assembly, the transverse support structure includes a front bar, a rear bar and three intermediate support members, all three intermediate support members are provided between the front bar and the rear bar, the intermediate support members are staggered with the rotating shaft joint assembly, the intermediate support member at the front end is provided in a integrated structure with the front bar, the intermediate support member at the rear end is provided in a integrated structure with the rear bar, the three intermediate support members are, from front to rear, a front bar fixing system, an intermediate fixing bar and a wrench fixing system, or a front bar fixing system and two wrench fixing systems, or a wrench fixing system, an intermediate fixing bar and a wrench fixing system, or three wrench fixing systems.

A soft cover folding car cover includes a longitudinal support structure and a transverse support structure connected to the longitudinal support structure, the longitudinal support structure and the transverse support structure are used to support the leather, the leather can be directly connected to the longitudinal support structure and the transverse support structure to form a waterproof car cover, the longitudinal support structure includes two side rail assemblies, each side rail assembly includes a plurality of side rails, two adjacent side rails are connected to each other by a rotating shaft joint assembly, the rotating shaft joint assembly is either a first rotating shaft joint assembly, a second rotating shaft joint assembly or a third rotating shaft joint assembly. The transverse support structure includes a front bar, a rear bar and four intermediate supports, all four intermediate supports are provided between the front bar and the rear bar, the intermediate supports are staggered with the rotating shaft joint assembly, the intermediate support on the front end is provided in an integrated structure with the front bar, the intermediate support on the rear end is provided in an integrated structure with the rear bar. the four intermediate supports are, from front to rear, either a front bar fixing system and three wrench fixing systems, or a front bar fixing system, an intermediate support system and two wrench fixing system, or a front bar fixing system, two intermediate fixing bars and a wrench fixing system, or four wrench fixing systems, or a wrench fixing system, two intermediate fixing bars and a wrench fixing system, or two wrench fixing systems, an intermediate fixing bars and a wrench fixing system.

A soft cover folding car cover includes a longitudinal support structure and a transverse support structure connected to the longitudinal support structure, the longitudinal support structure and transverse support structure are used to support the leather, the longitudinal support structure includes two side rail assemblies, each side rail assembly includes a plurality of side rails, two adjacent side rails are connected to each other by a rotating shaft joint assembly, the rotating shaft joint assembly is either a first rotating shaft joint assembly, a second rotating shaft or a third rotating shaft system, the number of rotating shaft joint assemblies is related to the number of times the cover is folded, generally the car cover can be folded three to four times, more rotating shaft joint assemblies can be provided for longer hoppers, similar designs are within the scope of protection of this invention, the transverse support structure includes a front bar, a rear bar and four intermediate support members, the intermediate support members are provided between the front bar and the rear bar, the intermediate support members are staggered with the rotating shaft joint assemblies, the intermediate support on the front end is provided in an integrated structure with the front bar, the intermediate support on the rear end is provided in an integrated structure with the rear bar, the front and rear bars are connected to the two sides of the side rail assembly, the front bar, rear bar and side rail assemblies form a rectangular frame, the intermediate supports are set in the rectangular frame, the four intermediate supports are, from front to rear, either a front bar fixing system and three lock bolt fixing systems, or a front bar fixing system, an intermediate fixing bar and two lock bolt fixing systems, or a front bar fixing system, two intermediate fixing bars and a lock bolt fixing system, or a front bar fixing system, a lock bolt fixing system, an intermediate fixing bar and a lock bolt fixing system, or four lock bolt fixing systems, or a lock bolt fixing system, an intermediate fixing bar and two lock bolt fixing systems, or a lock bolt fixing system, two intermediate fixing bars and a lock bolt fixing system.

A soft cover folding car cover includes a longitudinal support structure and a transverse support structure connected to the longitudinal support structure, the longitudinal support structure and the transverse support structure are used to support a leather, the longitudinal support structure includes two side rail assemblies, each side rail assembly includes a plurality of side rails, two adjacent side rails are connected to each other by a rotating shaft joint assembly, the rotating shaft joint assembly is either a first rotating shaft joint assembly or a second rotating shaft joint assembly, the transverse support structure includes a front bar, a rear bar and three intermediate support members, the three intermediate support members are provided between the front bar and the rear bar, the intermediate support members are staggered with the rotating shaft joint assembly, the intermediate support on the front end is provided in an integrated structure with the front bar, the intermediate support on the rear end is provided in an integrated structure with the rear bar, the three intermediate support members are, from front to rear, either a front bar fixing system, a lock bolt fixing system, a lock bolt fixing system, or a front bar fixing system, an intermediate fixing bar, a lock bolt fixing system or a lock bolt fixing system, an intermediate fixing bar, a lock bolt fixing system, or three lock bolt fixing systems.

Further, the second rotating shaft joint assembly includes a left joint, an intermediate joint and a right joint, the left joint and the right joint are connected to the intermediate joint respectively, the left joint and the right joint are used to connect the side rail, the right joint is provided with a right joint groove, the intermediate joint is provided with an intermediate joint insert at one end and an intermediate joint groove at the other end, the left joint is provided with a left joint insert, the left joint insert is rotatably connected to the intermediate joint groove, the intermediate joint insert is rotatably connected to the right joint groove, the left joint insert is connected to the intermediate joint groove by a spring pin, the intermediate joint insert is connected to the right joint groove by a spring pin, both sides of the right joint groove are provided with two right joint groove edges, the right joint groove edge is provided with a right joint hole, the intermediate joint insert is provided with a first intermediate joint hole, the first intermediate joint hole is provided in correspondence with the right joint hole, the spring pin passes through the first intermediate joint hole and the right joint hole, both sides of the intermediate joint groove are provided with two intermediate joint groove edges, the intermediate joint groove edge is provided with a second intermediate joint hole, the left joint insert is provided with a left joint hole, the second intermediate joint hole is provide in correspondence with the left joint hole, the spring pin passes through the second intermediate joint hole and the left joint hole, the left joint and the right joint are used to connect the side rail, and at the same time, the left joint and the right join are made to rotate with respect to the intermediate joint respectively, so as to realize the turning of the car cover. Secondly, the rotating joint assembly is designed in an asymmetric structure, with the intermediate joint is provided with a insert and a groove, so that when the waterproof leather is laid on the upper surface of the car cover, the leather will not be piled up in the middle or pulled to the two sides during the process of rotation, but will move to one side at the same time, which can prevent the waterproof leather from being damaged.

Further, the front bar fixing system includes a ball threaded rod, an insert, a slider, a plum nut, a sliding bar, a catch and a side rail slider, the slider is sliding along the sliding bar, the slider is provided with a ball groove and a mounting channel, the ball groove is connected to the mounting channel, the mounting channel is provided with an insertion groove, the insertion groove is detachably connected to an insert, the catch is connected to the sliding bar by a ball threaded rod, the ball threaded rod is connected with a plum nut, the side rail slider is connected to both ends of the sliding bar, the ball threaded rod includes a ball head, a square structure and a threaded rod, the ball head and the threaded rod are connected to both ends of the square structure. The ball head is mainly fitted to the slider, a catch is snapped onto the threaded rod, followed by a plum nut attached to the threaded rod, using the catch to connect the front bar to the guide rail or the body of the vehicle, the sliding bar is provided with a sliding groove, the slider is provided in the sliding groove, the slider is provided with a U-shaped cutout, the slider is provided with a side channel, the side channel is provided with a semi-circular catch, when the slider is moved to the point where the side channel corresponds to the insertion groove, the threaded rod can be rotated to a horizontal state through the side channel, the catch has two working positions, one of which is the ball threaded rod perpendicular to the sliding bar on the lower side of the sliding bar, the catch clamps the guide rail, the other working position is that the ball threaded rod located in the U-shaped side cutout in a horizontal state, the catch clamps the front bar.

Further, the wrench fixing system includes a wrench side rail slider, a wrench sliding bar, a wrench, a ball screw, a wrench slider and a slider insert, the wrench slider is sliding along the wrench sliding bar, the wrench slider is provided with a ball groove and a mounting channel, the ball groove is connected to the mounting channel, the mounting channel is provided with an insertion groove, the insertion groove is detachably connected to a wrench insert, the wrench is connected to the ball screw, the wrench side rail slider is connected to both ends of the wrench sliding bar, the ball screw includes a screw, the wrench sliding bar is provided with a sliding groove, the wrench slider is provided in the sliding groove, the sliding groove is provided with a U-shaped cutout, the wrench slider is provided with a side channel, the side channel is provided with a wrench semicircular catch, the screw can be seated on the wrench semi-circular catch to lock the ball screw in the side channel, while the cutout keeps the ball screw from interfering with the wrench slider, when the wrench slider moved to the point where the side channel corresponds to the insertion groove, the screw can be rotated to a horizontal state through the side channel.

Further, the wrench sliding bar is provided with a side groove, the side rail slider includes a side rail baffle and a sliding bar insert connected to the side rail baffle, the side rail baffle is provided with a socket and a threaded hole, the sliding bar insert is provided in the side sliding groove, the side rail slider is connected to both ends of the sliding bar, the sliding bar insert extends into the side grooves on both sides of the sliding bar to fix the sliding bar in place, and then screws are connected through the threaded holes to fix the side rail slider to the side rail.

Further, the wrench sliding bar is provided with a wrench sliding groove, the wrench slider is provided in the wrench sliding groove, the sliding groove is provided with a cutout, the wrench slider is provided with a side channel, the side channel is provided with a wrench semi-circular catch, when the slider is moved to the point where the side channel corresponds to the insertion groove, the screw can be rotated to a horizontal state through the side channel.

A soft cover structure includes a front bar, a front bar fixing system, a lock bolt fixing system, an intermediate fixing bar, a rear bar, a first rotating shaft joint assembly, a second rotating shaft joint assembly, a third rotating shaft joint assembly, a side rail assembly and a guide rail.

A soft cover folding car cover includes a longitudinal support structure and a transverse support structure connected to the longitudinal support structure.
The longitudinal support structure includes two side rail assemblies, each side rail assembly includes a plurality of side rails, two adjacent side rails are connected to each other by a first rotating shaft joint assembly, a second rotating shaft joint assembly or a third rotating shaft joint assembly.
The transverse support structure includes a front bar, a rear bar and an intermediate support member, the intermediate support member is provided between the front bar and the rear bar, the intermediate support member includes one or a combination of a front bar fixing system, a lock bolt fixing system and an intermediate bar fixing system, the intermediate support member is connected to the longitudinal support structure, the front bar, the rear bar and the intermediate support member are all provided on the upper side of the rails, the car cover is connected to the guide rail through a front bar extension plate, the guide rail is connected to the car body by a rail clamp, the threaded rod is connected to the front bar fixing block slider through the front bar extension plate.

Further, the front bar, the front bar fixing system, the wrench fixing system, the intermediate fixing bar and the rear bar are of the same or different lengths, the front bar, the front bar fixing system, the wrench fixing system, the intermediate fixing bar and the rear bar are the same or different widths, the front bar, front bar fixing system, wrench fixing system, intermediate fixing bar and rear bar form a transverse support structure, so that if the lengths of the components in the transverse support structure are all the same, the car cover as a whole is of rectangular structure, if the lengths of the components in the transverse support structure are different, the car cover as a whole is of trapezoidal structure. The transverse support structure has various widths of the components, allowing different widths of the transverse support structure to be used according to the differences in the parts to be supported, which ensures the support force while saving material as much as possible.

The beneficial effects of the present invention are:

By improving the structure of the car cover, using the longitudinal support structure and the transverse support structure to form the skeleton of the car cover, and then directly connecting the leather on the car cover, the whole car cover is not only light in quality and easy to operate, but also saves the material used and greatly reduces the production cost.

### DESCRIPTION OF DRAWINGS

FIG. 1 is a structural schematic diagram of the present invention.

FIG. 2 is a structural schematic diagram I of the front bar fixing system.

FIG. 3 is a structural schematic diagram II of the front bar fixing system.

FIG. 4 is a partially enlarged view of part A in FIG. 3.

FIG. 5 is a partially enlarged view of part B of FIG. 3.

FIG. 6 is a structural schematic diagram I of the wrench fixing system.

FIG. 7 is a structural schematic diagram II of the wrench fixing system.

FIG. 8 is a partially enlarged view of part C in FIG. 7.

FIG. 9 is a partially enlarged view of part D of FIG. 7.

FIG. 10 is a structural schematic diagram of Embodiment 4.

FIG. 11 is a partially enlarged view of part E in FIG. 10.

FIG. 12 is a structural schematic diagram of Embodiment 5.

FIG. 13 is a partially enlarged view of part F in FIG. 12.

FIG. 14 is a structural schematic diagram of Embodiment 5.

FIG. 15 is a partially enlarged view of part G in FIG. 14.

FIG. 16 is a schematic diagram of the connection of the ball threaded rod.

Figures: 1—Front bar. 2—Front bar fixing system. 201—Ball threaded rod. 2011—Ball head. 2012—Square structure. 2013—Threaded rod. 202—Insert. 203—Slider. 2033—Mounting channel. 2034—ball groove. 2035—Insertion groove. 2036—Side channel. 2037—Semi-circular catch. 2038—Ladder structure. 204—Plum nut. 205—Sliding bar. 2051—Sliding groove. 2053—Side sliding groove. 2054—U-shaped cutout. 206—Catch. 207—Side rail slider. 2071—Side rail baffle. 20711—Socket. 20712—Threaded hole. 2073—Sliding bar insert. 3—Wrench fixing system. 301—Wrench side rail slider. 302—Wrench sliding bar 3021—Wrench sliding groove. 3022—Cut-out. 303—Wrench. 304—Ball screw. 3041—Screw. 305—Wrench slider. 3051—Wrench semi-circular catch. 306—Wrench insert. 4—Intermediate fixing bar. 5—Rear bar. 6—First rotating shaft joint assembly. 7—Second rotating shaft joint assembly. 701—Spring pin. 702—Left joint. 7021—Left joint insert. 703—Intermediate joint. 7031—Intermediate joint insert. 7032—Intermediate joint groove edge. 704—Right joint. 7041—Right joint hole. 7042—Right joint groove edge. 8—Third rotating shaft joint assembly. 9—Side rail. 10—Guide rail. 1001—Guide rail clamp. 1002—Front bar extension plate. 11—Lock bolt fixing system.

### The Concrete Method to Carry Out

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present invention and the features in the embodiments is either combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it is either a mechanical connection or an electrical connection. it is either a direct connection or an indirect connection through an intermediate media. And it is either internal connection within two assemblies. For those of ordinary skill in this field, specific meanings of the above terms in the present invention is either understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

A soft cover folding car cover includes a longitudinal support structure and a transverse support structure connected to the longitudinal support structure, the longitudinal support structure and transverse support structure are used to support the leather, by forming the skeleton of the car cover through the longitudinal support structure and the transverse support structure, and then directly connecting the waterproof leather to the skeleton of the car cover, it can reduce the weight of the car cover as much as possible and lower the cost of the car cover while playing a waterproof effect,

The longitudinal support structure includes two side rail assemblies (which are connected on both sides of the car cover), each side rail assembly includes a plurality of side rails 9 (corresponding side rails 9 are set up according to the number of rotating shaft joint assemblies), two adjacent side rails 9 are connected to each other by a rotating shaft joint assembly, the rotating shaft joint assembly is either a first rotating shaft joint assembly 6 or a second rotating shaft joint assembly 7, the first rotating shaft joint assembly 6 is larger while the second rotating shaft joint assembly 7 is smaller, or the first rotating shaft joint assembly 6 and the second rotating shaft joint assembly 7 are of the same size. (the first rotating shaft joint assembly 6 and the second rotating shaft joint assembly 7 can be of the same or different structure and be of the same or different size, as long as it enables the two adjacent side rails 9 can rotate relative to each other, two rotating shaft joint assemblies mean that the cover can be turned over and folded twice).

The transverse support structure includes a front bar 1, a rear bar 5 and three intermediate supports, all three intermediate supports are provided between the front bar 1 and the rear bar 5, the intermediate support members are staggered with the rotating shaft joint assembly (the rotating shaft joint assembly is the folding centre of the car cover, two rotating shaft joint assemblies separate the cover into three parts, each part is connected to an intermediate support member, the intermediate support member can function as a lock or only as a support). The intermediate support at the front is provide in an integrated structure with the front bar 1, the intermediate support at the rear is provided in an integrated structure with the rear bar 5 (the front end is the end of the cover near the front bar 1, the rear end is the end of the cover near the rear bar 5), the three intermediate supports are, from front to rear, a front bar fixing system 2, an intermediate fixing bar 4 and a wrench fixing system 3, or a front bar fixing system 2 and two wrench fixing systems 3, or a wrench fixing system 3, an intermediate fixing bar 4 and a wrench fixing system 3, or three wrench fixing systems 3. (The front bar 1 and the rear bar 5 are connected to both ends of the side rail assembly, the front bar 1, rear bar 5 and side rail assembly form a rectangular frame, the intermediate support members are provided in the rectangular frame, the intermediate support members can be arranged in random ways, as long as they can ensure a stable connection of the car cover).

### Embodiment 2

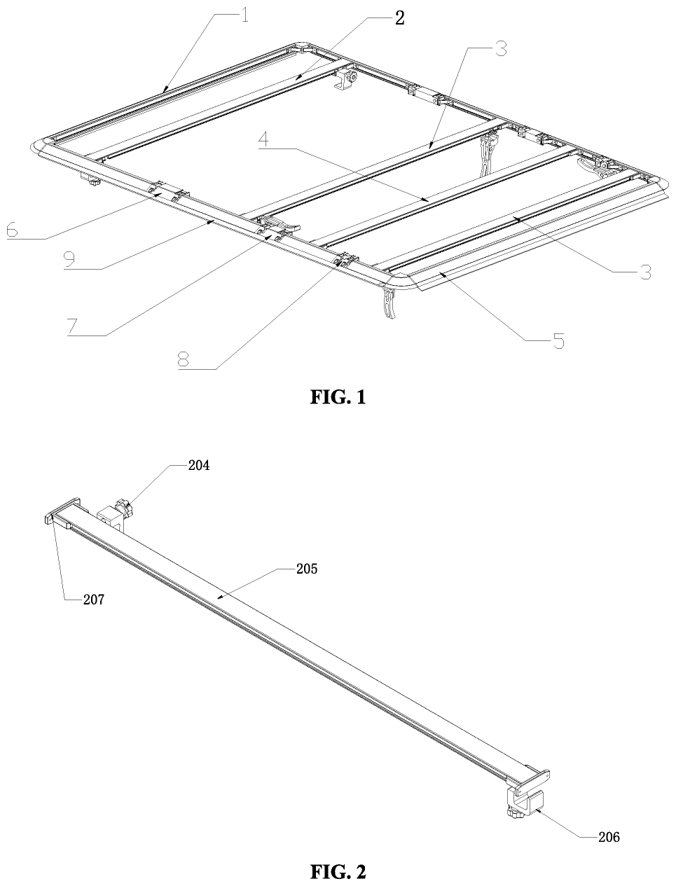

As shown in FIG. 1, a soft cover folding car cover includes a longitudinal support structure and a transverse support structure connected to the longitudinal support structure, the longitudinal support structure and the transverse support structure are used to support a leather (not shown on the drawing), the leather can be directly connected to the waterproof car cover formed by the longitudinal support structure and the transverse support structure.

The longitudinal support structure includes two side rail assemblies (the side rail assemblies are connected on both sides of the cover), each side rail assembly includes a plurality of side rails 9 (corresponding side rails 9 are set up according to the number of rotating shaft joint assemblies), two adjacent side rails 9 are connected to each other by a rotating shaft joint assembly, the rotating shaft joint assembly is either a first rotating shaft joint assembly 6, a second rotating shaft joint assembly 7 or a third rotating shaft joint assembly 8, the first rotating shaft joint assembly 6 is larger while the second rotating shaft joint assembly 7 and the third rotating shaft joint assembly 8 are smaller, or the first rotating shaft joint assembly 6 and the second rotating shaft joint assembly 7 are larger while the third rotating shaft joint assembly 8 is smaller, or the first rotating shaft joint assembly 6, the second rotating shaft joint assembly 7 and the third rotating shaft joint assembly 8 are of equal size, or the first rotating shaft joint assembly 6 is larger than the second rotating shaft joint assembly 7 and further larger than the third rotating shaft 8 (the first rotating shaft joint assembly 6, second rotating shaft joint assembly 7 and third rotating shaft joint assembly 8 can be of the same or different structure and of the same or different size, as long as they enable the adjacent two side rails 9 to rotate relative to each other. three rotating shaft joint assemblies mean that the car cover can be turned over and folded three times).

The transverse support structure includes a front bar 1, a rear bar 5 and four intermediate supports, all of which are located between the front bar 1 and the rear bar 5, the intermediate supports are staggered with the rotating shaft joint assembly (the rotating shaft joint assembly is the folding centre of the car cover, three rotating shaft joint assemblies separate the car cover into four parts, each part is connected to an intermediate support, the intermediate support can function as a lock or only as a support). The intermediate support at the front end is provided in an integrated structure with the front bar 1, and the intermediate support at the rear end is provided in an integrated structure with the rear bar 5 (the intermediate support can also be in a separate structure with the front bar 1 and the rear bar 5 to facilitate the replacement of components). The four intermediate support members are, from front to back, either a front bar fixing system 2 and three wrench fixing systems 3, or a front bar fixing system 2, an intermediate fixing bar 4, and two wrench fixing systems 3, or a front bar fixing system 2, two intermediate fixing bars 4, and a wrench fixing system 3, or four wrench fixing systems 3, or a wrench fixing system 3, two intermediate fixing bars 4, and a wrench fixing system 3, or two wrench fixing systems 3, an intermediate fixing bar 4, a wrench fixing system 3. (The front bar 1 and the rear bar 5 are connected to both ends of the side rail assembly, the front bar 1, the rear bar 5 and the side rail assembly form a rectangular frame, the intermediate support member is provided in the rectangular frame, the intermediate support member is arranged in random ways, as long as they can ensure a stable connection of the car cover).

### Embodiment 3

As shown in FIG. 10, a soft cover folding car cover includes a longitudinal support structure and a transverse support structure connected to the longitudinal support structure, the longitudinal support structure and transverse support structure are used to support the leather. The longitudinal support structure includes two side rail assemblies (the side rail assemblies are connected to both sides of the cover), each side rail assembly includes a plurality of side rails 9 (corresponding side rails 9 are set up according to the number of rotating shaft joint assemblies), two adjacent side rails 9 are connected to each other by a rotating shaft joint assembly, the rotating shaft joint assembly is either a first rotating shaft joint assembly 6, a second rotating shaft joint assembly 7, or a third rotating shaft joint assembly 8, the first rotating shaft joint assembly 6 is larger while the second rotating shaft joint assembly 7 and the third rotating shaft joint assembly 8 are smaller, or the first rotating shaft joint assembly 6 and the second rotating shaft joint assembly 7 are larger while the third rotating shaft joint assembly 8 is smaller, or the first rotating shaft joint assembly 6, the second rotating shaft joint assembly 7 and the third rotating shaft joint assembly 8 are of equal size, or the first rotating shaft joint assembly 6 is larger than the second rotating shaft joint assembly 7 and further larger than the third rotating shaft 8. The number of rotating shaft joint assemblies is related to the number of times the car cover is folded, generally speaking, the car cover has to be folded three to four times, and more rotating shaft joint assemblies can be provided for longer car hoppers, more similar designs are within the scope of protection of the present application. (the structures of the first rotating shaft joint assembly 6, second rotating shaft joint assembly 7, third rotating shaft joint assembly 8 can be of same or different structure, or two of them can be the same and the other is different, and they can be of same or different size, or two of them are the same and the other is different, as long as they enable adjacent two side rails 9 rotate relative to each other, three rotating shaft joint assemblies mean that the car cover can be turned and folded three times).

The transverse support structure includes a front bar 1, a rear bar 5 and four intermediate support members, the intermediate support members are located between the front bar 1 and the rear bar 5, the intermediate support members are staggered with the rotating shaft joint assembly, the intermediate support member at the front is provided in an integral structure with the front bar 1, the intermediate support member at the rear end is provided in an integral structure with the rear bar 5, the front bar 1 and the rear bar 5 are connected to both ends of the side rail assembly, the front bar 1, the rear bar 5 and the side rail assembly form a rectangular frame, the intermediate support members are provided in the rectangular frame, the four intermediate support members are, from front to back, a front bar fixing system 2 and three lock bolt fixing systems 11, or a front bar fixing system 2, a intermediate fixing bar 4, and two lock bolt fixing systems 11, or a front bar fixing system 2, two intermediate fixing bars 4, and a lock bolt fixing systems 11, or a front bar fixing system 2, a lock bolt fixing system 11, a intermediate fixing bar 4, and a lock bolt fixing system 11, or four lock bolt fixing systems 11, or a lock bolt fixing system 11, an intermediate fixing bar 4 and two lock bolt fixing systems 11, or a lock bolt fixing system 11, two intermediate fixing bars 4 and a lock bolt fixing system 11 (all of the foregoing are arranged from front to back).

### Embodiment 4

As shown in FIG. 10, a soft cover folding car cover includes a longitudinal support structure and a transverse support structure connected to the longitudinal support structure, the longitudinal support structure and transverse support structure are used to support the leather.

The longitudinal support structure includes two side rail assemblies (the side rail assemblies are connected to both sides of the cover), each side rail assembly includes a plurality of side rails 9 (corresponding side rails 9 are set according to the number of rotating shaft connector assemblies), two adjacent side rails 9 are connected to each other by a rotating shaft joint assembly, the rotating shaft joint assembly is a either a first rotating shaft joint assembly 6 or a second rotating shaft joint assembly 7, the first rotating shaft joint assembly 6 is larger while the second rotating shaft joint assembly 7 is smaller, or the first rotating shaft joint assembly 6 and the second rotating shaft joint assembly 7 are of the same size (the first rotating shaft joint assembly 6 and second rotating shaft joint assembly 7 can be of the same or different structure, and of the same or different size, as long as they enable adjacent two side rails 9 rotate relative to each other, the two rotating shaft joint assemblies mean that the car cover can be turned over and folded twice).

The transverse support structure includes a front bar 1, a rear bar 5 and three intermediate support members, the three intermediate support members are located between the front bar 1 and the rear bar 5, the intermediate support members are staggered with the rotating shaft joint assembly, the intermediate support member at the front end is provided in an integrated structure with the front bar 1, the intermediate support member at the rear end is provided in an integrated structure with the rear bar 5, the three intermediate support members are, from front to back, either a front bar fixing system 2, a lock bolt fixing system 11 and a lock bolt fixing system 11, or a front bar fixing system 2, an intermediate fixing bar 4 and a lock bolt fixing system 11, or a lock bolt fixing system 11, an intermediate fixing bar 4 and a lock bolt fixing system 11, or three lock bolt fixing systems 11 (the front bar 1 and the rear bar 5 are connected to both ends of the side rail assembly, the front bar 1, the rear bar 5 and the side rail assembly form a rectangular frame, the intermediate support member is provided in the rectangular frame, the intermediate support member may be of any combination).

### Embodiment 5

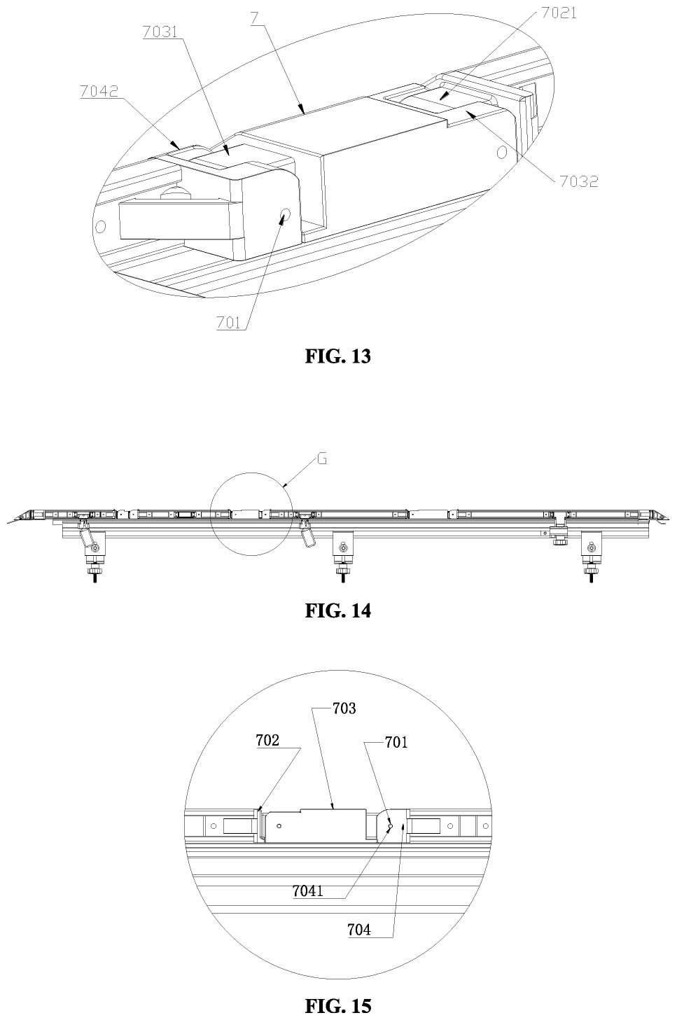

On the basis of Embodiments 1-4, as shown in FIGS. 12-15, the second rotating shaft joint assembly 7 includes a left joint 702, an intermediate joint 703, and a right joint 704, the left joint 702 and right joint 704 are connected to the intermediate joint 703 respectively, the left joint 702 and the right joint 704 are used to connect to the side rail 9.

The right joint 704 is provided with a right connector groove, the intermediate joint 703 is provided with an intermediate joint insert 7031 at one end and an intermediate joint groove at the other end, the left joint 702 is provided with a left joint insert 7021, which is rotationally connected to the intermediate joint groove, the intermediate joint insert 7031 is rotationally connected to the right joint groove.

The left joint insert 7021 is connected to the intermediate joint groove by a spring pin 701, the intermediate joint insert 7031 is connected to the right joint groove by a spring pin 701.

Two sides of the right joint groove are provided with two right joint groove edges 7042, the right joint groove edge 7042 is provided with a right joint hole 7041, the intermediate joint insert 7031 is provided with a first intermediate joint hole, the first intermediate joint hole is provided in correspondence with the right joint hole 7041, the spring pin 701 passes through the first intermediate joint hole and the right joint hole 7041.

Two sides of the intermediate joint groove are provided with two intermediate joint groove edges 7032, the intermediate joint groove edge 7032 is provided with a second intermediate joint holes, the left joint insert 7021 is provided with a left joint hole, the second intermediate joint hole is provided in correspondence with the left joint hole, the spring pin 701 passes through the second intermediate joint hole and the left joint hole.

The left joint 702 and the right joint 704 are used to connect the side rail 9, the left joint and the right join are made to rotate with respect to the intermediate joint respectively, so as to realize the turning of the car cover. secondly, the rotating shaft joint assembly is designed in an asymmetric structure, and the intermediate joint 703 is provided with an intermediate joint insert 7031 and a groove, so that when the waterproof leather is laid on the upper surface of the car cover, the leather will not be piled up in the middle or pulled to the two sides during the process of rotation, but will move to one side at the same time, which can prevent the waterproof leather from being damaged.

### Embodiment 6

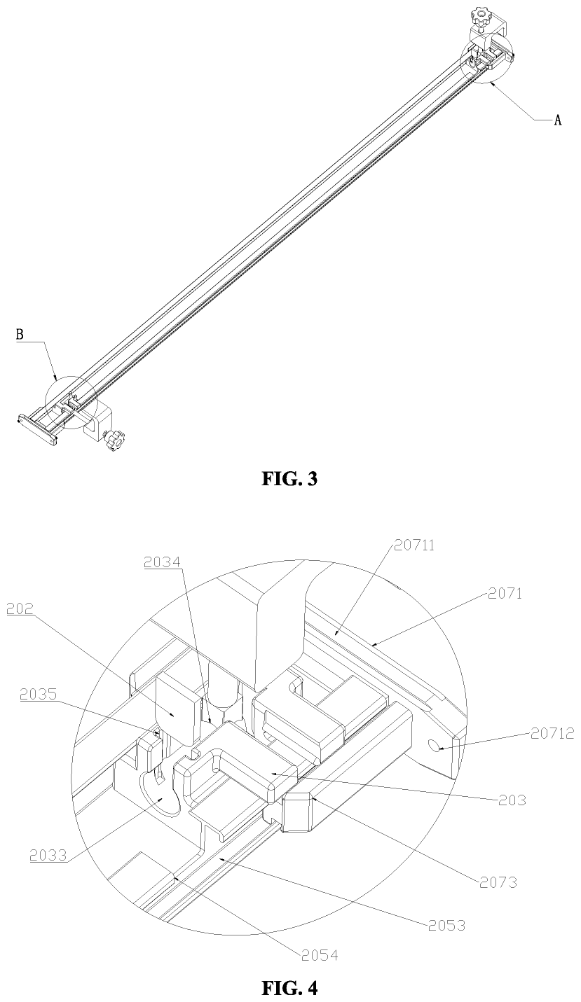

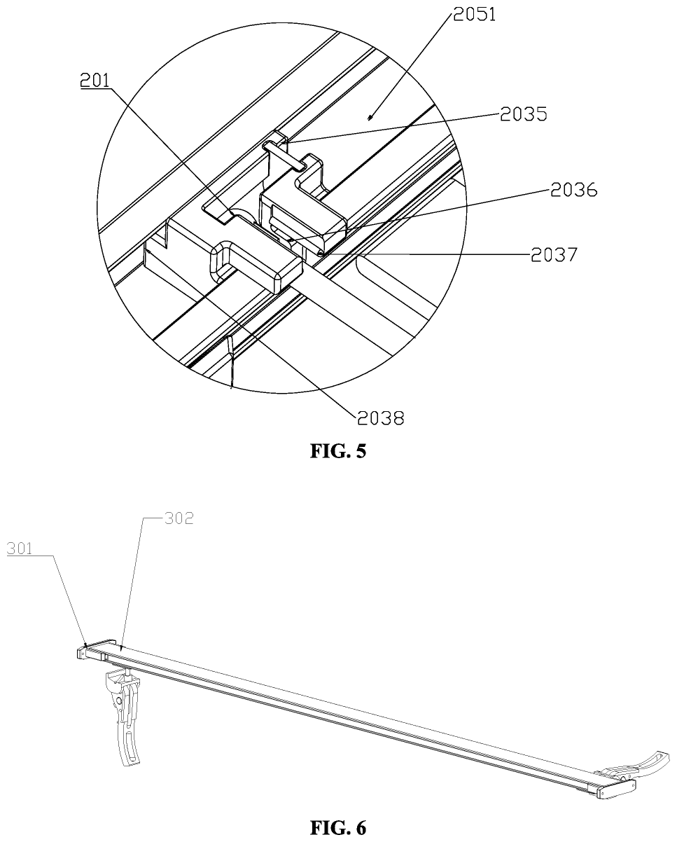

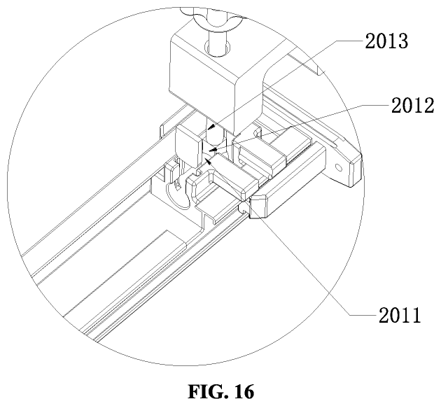

On the basis of Embodiment 5, as shown in FIGS. 2-5 and 16, the front bar fixing system 2 includes a ball threaded rod 201, an insert 202, a slider 203, a plum nut 204, a sliding bar 205, a catch 206, and a side rail slider 207, the slider 203 is sliding along the sliding bar 205, the slider 203 is of a ladder structure, the slider 203 is provided with a ball groove 2034 and a mounting channel 2033, the ball groove 2034 is connected to the mounting channel 2033, the mounting channel 2033 is provided with an insertion groove 2035, the insertion groove 2035 is detachably connected with an insert 202, the catch 206 is connected to the sliding bar 205 by a ball threaded rod 201, the ball threaded rod 201 is connected with a plum nut 204, the side rail slider 207 is connected to both ends of the sliding bar 205.

The ball head threaded rod 201 includes a ball head 2011, a square structure 2012 and a threaded rod 2013, the ball head 2011 and the threaded rod 2013 are respectively connected to both ends of the square structure 2012. The ball head 2011 is mainly fitted with the slider 203, a catch 206 is socketed on the threaded rod 2013, and then a plum nut 204 is connected to the threaded rod 2013, and the catch 206 is snapped onto the front bar 1 to connected the guide rail 10 or the car body.

The sliding bar 205 is provided with a sliding groove 2051, the slider 203 is provided in the sliding groove 2051, the sliding groove 2051 is provided with a U-shaped cutout 2054, the slider 203 is provided with a side channel 2036, the side channel 2036 is provided with a semicircular catch 2037.

When the slider 203 is moved to the point where the side channel 2036 corresponds to the insertion groove 2035, the threaded rod 2013 can be rotated to a horizontal state through the side channel 2036.

When installing, the ball 2011 of the ball threaded rod 201 is first slid into the ball groove 2034 from the mounting channel 2033, the insert block 202 is then inserted into the insertion groove 2035, thereby closing the mounting channel 2033 and preventing the ball 2011 from sliding out of the mounting channel 2033, the ball threaded rod 201 can be slid within the ball groove 2034, by the setting of the square structure 2012, it can prevent the ball head threaded rod 201 from rotating.

The catch 206 has two working positions, one of which is the ball head threaded rod 201 perpendicular to the sliding bar 205 on the lower side of the sliding bar 205, the catch 206 clamps the guide rail 10, the other working position is that the ball head threaded rod 201 is located in the U-shaped side cutout 2054 in a horizontal position, the catch 206 clamps the front bar 1.

### Embodiment 7

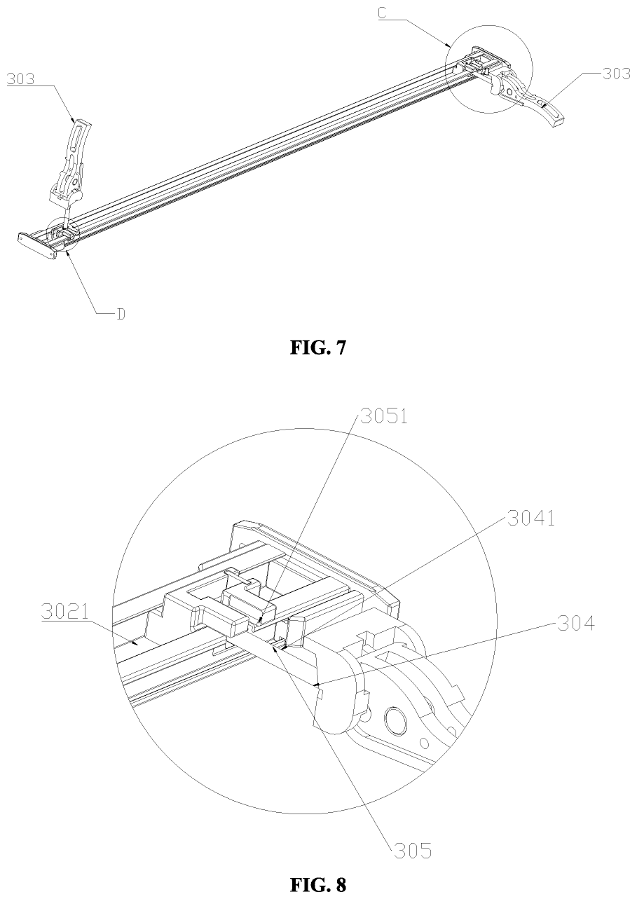

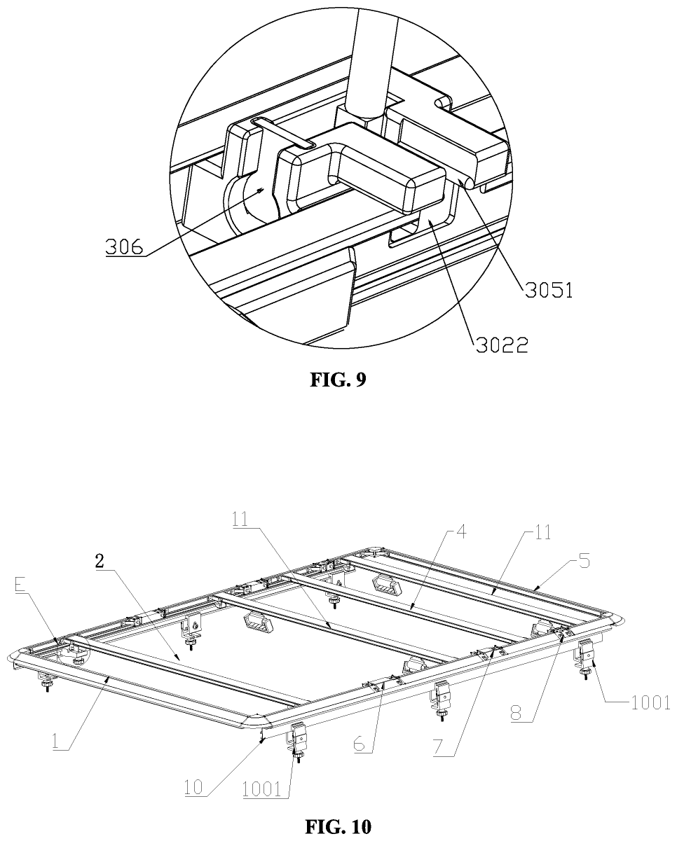

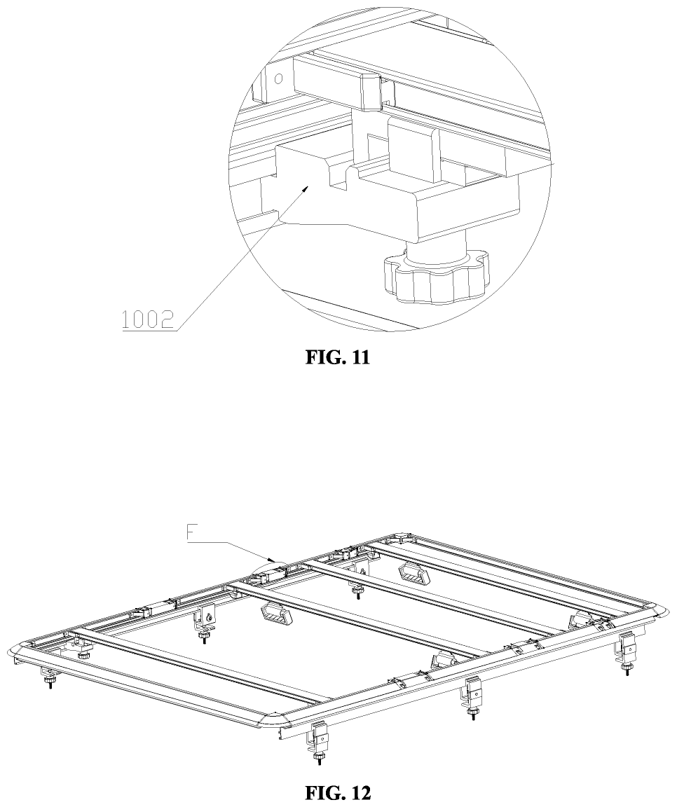

On the basis of Embodiment 6, as shown in FIGS. 6-9, the wrench fixing system 3 includes a wrench side rail slider 301, a wrench sliding bar 302, a wrench 303, a ball screw 304, a wrench slider 305, and a wrench insert 306, the wrench slider 305 is sliding along the wrench sliding bar 302, the wrench slider 305 is provided with a ball groove 2034 and a mounting channel 2033, the ball groove 2034 is connected to the mounting channel 2033, the mounting channel 2033 is provided with an insertion groove 2035, the insertion groove 2035 is detachably connected to a wrench insert 306, the wrench 303 is connected to the ball screw 304, the wrench side rail slider 301 is connected to both ends of the wrench sliding bar 302, the ball screw 304 includes a screw 3041.

The wrench sliding bar 302 is provided with a wrench sliding groove 3021, the wrench slider 305 is provided in the wrench sliding groove 3021, the wrench sliding groove 3021 is provided with a cutout 3022, the wrench slider 305 is provided with a side channel 2036, the side channel 2036 is provided with a wrench semi-circular catch 3051, the screw 3041 can be seated on the wrench semi-circular catch 3051 to lock the ball screw 304 in the side channel 2036, while the cutout 3022 keeps the ball screw 304 from interfering with the wrench slider 302.

When the wrench slider 305 moved to the point where the side channel 2036 corresponds to the insertion groove 2035, the screw 3041 can be rotated to a horizontal state through the side channel 2036.

### Embodiment 8

On the basis of Embodiment 6, the sliding bar 205 is provided with side sliding groove 2053, the side rail slider 207 includes a side rail baffle 2071 and a sliding bar insert 2073 connected to the side rail baffle 2071, the side rail baffle 2071 is provided with a socket 20711 and a threaded hole 20712, the sliding bar insert 2073 is provided in the side sliding groove 2053.

The side rail slider 207 is connected to both ends of the sliding bar 205, the sliding bar insert 2073 extends into the side grooves 2053 on both sides of the sliding bar 205 to secure the sliding bar 205, and then screws are connected through the threaded holes 20712 to secure the side rail slider 207 to the side rail 9.

### Embodiment 9

On the basis of Embodiment 7, the wrench sliding bar 302 is provided with a wrench sliding groove 3021, the wrench slider 305 is provided in the wrench sliding groove 3021, the wrench sliding groove 3021 is provided with a cutout 3022, the wrench slider 305 is provided with a side channel 2036, the side channel 2036 is provided with a wrench semicircular catch 3051.

When the slider 203 is moved to the point where the side channel 2036 corresponds to the insertion groove 2035, the screw 3041 can be rotated to a horizontal state through the side channel 2036.

When installing, the ball head 2011 of the ball screw 304 is first slid into the ball groove 2034 from the mounting channel 2033, and then the wrench insert 306 is inserted into the insertion groove 2035, thereby closing the mounting channel 2033 and preventing the ball head 2011 from sliding out of the mounting channel 2033, the ball screw 304 can slid within the ball groove 2034, by the setting of the square structure 2012, it can prevent the ball head threaded rod 201 from rotating. The wrench 303 can rotate over the screw 3041 in the vertical plane and can slide along the wrench sliding groove 3021 with the wrench 303 fixed to the wrench slider 305.

### Embodiment 10

A soft cover folding car cover includes a longitudinal support structure and a transverse support structure connected to the longitudinal support structure.

The longitudinal support structure includes two side rail assemblies (which are connected to both sides of the cover), each side rail assembly includes a plurality of side rails 9 (corresponding side rails 9 are set according to the number of rotating shaft joint assemblies), two adjacent side rails 9 are connected to each other by a first rotating shaft joint assembly 6, a second rotating shaft joint assembly 7, or a third rotating shaft joint assembly 8. (the first rotating shaft joint assembly 6, second rotating shaft joint assembly 7 and third rotating shaft joint assembly 8 can be of the same or different structure, or two of them can be same and the other different, they can be of the same or different size, or two of them can be the same and the other different, as long as they can enable adjacent two side rails 9 rotate relative to each other, the three rotating shaft joint assemblies mean that the car cover can be turned over and folded three times)

The transverse support structure includes a front bar 1, a rear bar 5 and an intermediate support member, the intermediate support member is provided between the front bar 1 and the rear bar 5, the intermediate support member includes one or a combination of a front bar fixing system 2, a lock bolt fixing system 11 and an intermediate bar fixing system, the intermediate support member is connected to the longitudinal support structure.

### Embodiment 11

On the basis of embodiment 10, the front bar 1, the rear bar 5 and the intermediate support member are all provided on the upper side of the guide rail 10.

The car cover is connected to the guide rail 10 through a front bar extension plate 1002. the guide rail 10 is connected to the body of the car through a guide rail clamp 1001.

The threaded rod 2013 is connected to the front bar 1 fixing block slider 203 through the front bar extension plate 1002.

### Embodiment 12

On the basis of Embodiments 1, 2 and 10, the front bar 1, the front bar fixing system 2, the wrench fixing system 3, the intermediate fixing bar 4 and the rear bar 5 are of the same or different lengths.

The front bar 1, the front bar fixing system 2, the wrench fixing system 3, the intermediate fixing bar 4 and the rear bar 5 are of the same or different widths.

The front bar 1, the front bar fixing system 2, the wrench fixing system 3, the intermediate fixing bar 4 and the rear bar 5 form a transverse support structure, so that if the lengths of the components in the transverse support structure are all the same, the car cover as a whole is of rectangular structure, if the lengths of the components in the transverse support structure are different, the car cover as a whole is of trapezoidal structure. Due to the different widths of the components in the transverse support structure, it is possible to use different widths of the transverse support structure according to the different parts supported, which ensures the support force and saves as much material as possible at the same time.

### Embodiment 13

On the basis of Embodiments 3, 4 and 10, the front bar 1, the front bar fixing system 2, the wrench fixing system 3, the intermediate fixing bar 4 and the rear bar 5 are of the same or different lengths.

The front bar 1, the front bar fixing system 2, the lock bolt fixing system 11, the intermediate fixing bar 4 and the rear bar 5 are of the same or different widths.

The front bar 1, the front bar fixing system 2, the lock bolt fixing system 11, the intermediate fixing bar 4 and the rear bar 5 form a transverse support structure, so that if the lengths of the components in the transverse support structure are all the same, the car cover as a whole is of rectangular structure, if the lengths of the components in the transverse support structure are different, the car cover as a whole is of trapezoidal structure. Due to the different widths of the components in the transverse support structure, it is possible to use different widths of the transverse support structure according to the different parts supported, which ensures the support force and saves as much material as possible at the same time.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A soft folding car cover, wherein, it includes a longitudinal support structure and a transverse support structure connected to the longitudinal support structure, the longitudinal support structure and transverse support structure are used to support the leather.
The longitudinal support structure includes two side rail assemblies, each side rail assembly includes a plurality of side rails (9), two adjacent side rails (9) are connected to each other by a rotating shaft joint assembly, the rotating shaft joint assembly is either a first rotating shaft joint assembly (6) or a second rotating shaft joint assembly (7), the first rotating shaft joint assembly (6) is larger while the second rotating shaft joint assembly (7) is smaller, or the first rotating shaft joint assembly (6) and the second rotating shaft joint assembly (7) are of the same size.
The transverse support structure includes a front bar (1), a rear bar (5) and three intermediate support members, all three intermediate support members are provided between the front bar (1) and the rear bar (5), the intermediate support members are staggered with the rotating shaft joint assembly, the three intermediate support members are, from front to rear, a front bar fixing system (2), a intermediate fixing bar (4) and a wrench fixing system (3), or a front bar fixing system (2) and two wrench fixing systems (3), or a wrench fixing system (3), a intermediate fixing bar (4) and a wrench fixing system (3), or three wrench fixing systems (3).

2. A soft folding car cover, wherein, it includes a longitudinal support structure and a transverse support structure connected to the longitudinal support structure, the longitudinal support structure and transverse support structure are used to support the leather.
The longitudinal support structure includes two side rail assemblies, each side rail assembly includes a plurality of side rails (9), two adjacent side rails (9) are connected to each other by a rotating shaft joint assembly, the rotating shaft joint assembly is either a first rotating shaft joint assembly (6), a second rotating shaft joint assembly (7) or a third rotating shaft joint assembly (8), the first rotating shaft joint assembly (6) is larger while the second rotating shaft joint assembly (7) and the third rotating shaft joint assembly (8) are smaller, or the first rotating shaft joint assembly (6) and the second rotating shaft joint assembly (7) are larger while the third rotating shaft joint assembly (8) is smaller, or the first rotating shaft joint assembly (6), the second rotating shaft joint assembly (7) and the third rotating shaft joint assembly (8) are equal in size, or the first rotating shaft joint assembly (6) is larger than the second rotating shaft joint assembly (7) and further larger than the third rotating shaft joint assembly assembly (8).
The transverse support structure includes a front bar (1), a rear bar (5) and four intermediate support members, all four intermediate support members are provided between the front bar (1) and the rear bar (5), the intermediate support members are staggered with the rotating shaft joint assembly, the four intermediate support members are, from front to rear, either a front bar fixing system (2) and three wrench fixing systems (3), or a front bar fixing system (2), a intermediate fixing bar (4) and two wrench fixing systems (3), or a front bar fixing system (2), two intermediate fixing bars (4) and a wrench fixing system (3), or four wrench fixing systems (3), or a wrench fixing system (3), two intermediate fixing bars (4) and a wrench fixing system (3), or two wrench fixing systems (3), a intermediate fixing bar (4) and a wrench fixing system (3).

3. A soft folding car cover, wherein, it includes a longitudinal support structure and a transverse support structure connected to the longitudinal support structure, the longitudinal support structure and transverse support structure are used to support the leather.
The longitudinal support structure includes two side rail assemblies, each side rail assembly includes a plurality of side rails (9), two adjacent side rails (9) are connected to each other by a rotating shaft joint assembly, the rotating shaft joint assembly is either a first rotating shaft joint assembly (6), a second rotating shaft joint assembly (7) or a third rotating shaft joint assembly (8), the first rotating shaft joint assembly (6) is larger while the second rotating shaft joint assembly (7) and third rotating shaft joint assembly (8) are smaller, or the first rotating shaft joint assembly (6) and the second rotating shaft joint assembly (7) are larger while the third rotating shaft joint assembly (8) is smaller, or the first rotating shaft joint assembly (6), the second rotating shaft joint assembly (7) and the third rotating shaft joint assembly (8) are equal in size, or the first rotating shaft joint assembly (6) is larger than the second rotating shaft joint assembly (7) and further larger than the third rotating shaft joint assembly assembly (8).
The transverse support structure includes a front bar (1), a rear bar (5) and four intermediate support members, the intermediate support members are provided between the front bar (1) and the rear bar (5), the intermediate support members are staggered with the rotating shaft joint assembly, the four intermediate support members are, from front to rear, either a front bar fixing system (2) and three lock bolt fixing systems (11), or a front bar fixing system (2), an intermediate fixing bar (4) and two lock bolt fixing systems (11), or a front bar fixing system (2), two intermediate fixing bars (4) and a lock bolt fixing system (11), or a front bar fixing system (2), a lock bolt fixing system (11), a intermediate fixing bar (4) and a lock bolt fixing system (11), or four lock bolt fixing systems (11), or a lock bolt fixing system (11), an intermediate fixing bar (4) and two lock bolt fixing systems (11), or a lock bolt fixing system (11), two intermediate fixing bars (4) and a lock bolt fixing system (11).

4. A soft folding car cover, wherein, it includes a longitudinal support structure and a transverse support structure connected to the longitudinal support structure, the longitudinal support structure and transverse support structure are used to support the leather.
The longitudinal support structure includes two side rail assemblies, each side rail assembly includes a plurality of side rails (9), two adjacent side rails (9) are connected to each other by a rotating shaft joint assembly, the rotating shaft joint assembly is either a first rotating shaft joint assembly (6) or a second rotating shaft joint assembly (7), the first rotating shaft joint assembly (6) is larger while the second rotating shaft joint assembly (7) is smaller, or the first rotating shaft joint assembly (6) and the second rotating shaft joint assembly (7) are of the same size.
The transverse support structure includes a front bar (1), a rear bar (5) and three intermediate support members, the three intermediate support members are provided between the front bar (1) and the rear bar (5), the intermediate support members are staggered with the rotating shaft joint assembly, the three intermediate support members are, from front to rear, either a front bar fixing system (2), a lock bolt fixing system (11) and a lock bolt fixing system (11), or a front bar fixing system (2), an intermediate fixing bar (4) and a lock bolt fixing system (11), or a lock bolt fixing system (11), an intermediate fixing bar (4) and a lock bolt fixing system (11), or three lock bolt fixing systems (11).

5. A soft folding car cover according to claim 1, wherein the second rotating shaft joint assembly (7) includes a left joint (702), an intermediate joint (703) and a right joint (704), the left joint (702) and right joint (704) are connected to the intermediate joint (703) respectively, the left joint (702) and the right joint (704) are used to connect the side rail (9).
The right joint (704) is provided with a right joint groove, the intermediate joint (703) is provided with an intermediate joint insert (7031) at one end and an intermediate joint groove at the other end, the left joint (702) is provided with a left joint insert (7021), the left joint insert (7021) is rotatably connected to the intermediate joint groove, the intermediate joint insert (7031) is rotatably connected to the right joint groove.
The left joint insert (7021) is connected to the intermediate joint groove by a spring pin (701), the intermediate joint insert (7031) is connected to the right joint groove by a spring pin (701),
Two sides of he right joint groove are provided with two right joint groove edges (7042), the right joint groove edge (7042) is provided with a right joint hole (7041), the intermediate joint insert (7031) is provided with a first intermediate joint hole, the first intermediate joint hole is provided in correspondence with the right joint hole (7041), the spring pin (701) passes through the first intermediate joint hole and the right joint hole (7041).
Two sides of the intermediate joint groove are provided with two intermediate joint groove edges (7032), the intermediate joint groove edge (7032) is provided with a second intermediate joint hole, the left joint insert (7021) is provided with a left joint hole, the second intermediate joint hole is provided in correspondence with the left joint hole, the spring pin (701) passes through the second intermediate joint hole and the left joint hole.

6. A soft folding car cover according to claim 1, wherein, the front bar fixing system (2) includes a ball threaded rod (201), an insert block (202), a slider (203), a plum nut (204), a sliding bar (205), a catch (206) and a side rail slider (207), the slider (203) sliding along the sliding bar (205), the slider (203) is provided with a ball groove (2034) and a mounting channel (2033), the ball groove (2034) is connected to the mounting channel (2033), the mounting channel (2033) is provided with an insertion groove (2035), the insertion groove (2035) is detachably connected to an insert block (202), the catch (206) is connected to the sliding bar (205) by a ball threaded rod (201), the ball threaded rod (201) is connected with a plum nut (204), the side rail slider (207) is connected to both ends of the sliding bar (205), the ball threaded rod (201) is connected with a plum nut (204), the side rail slider (207) is connected to both ends of the sliding bar (205).
The ball threaded rod (201) includes a ball head (2011), a square structure (2012) and a threaded rod (2013), the ball head (2011) and the threaded rod (2013) are respectively connected to both ends of the square structure (2012).
The sliding bar (205) is provided with a sliding groove (2051), the slider (203) is provided in the sliding groove (2051), the sliding groove (2051) is provided with a U-shaped cutout (2054), the slider (203) is provided with a side channel (2036), the side channel (2036) is provided with a semi-circular catch (2037).

7. A soft folding car cover according to claim 6, wherein the wrench fixing system (3) includes a wrench side rail slider (301), a wrench sliding bar (302), a wrench (303), a ball screw (304), a wrench slider (305) and a wrench insert (306), the wrench slider (305) sliding along the wrench sliding bar (302), the wrench slider (305) is provided with a ball groove (2034) and a mounting channel (2033), the ball groove (2034) is connected to the mounting channel (2033), the mounting channel (2033) is provided with an insertion groove (2035), the insertion groove (2035) is detachably connected with a wrench insert (306), the wrench (303) is connected to the ball screw (304), the wrench side rail slider (301) is connected to both ends of the wrench sliding bar (302), the ball screw (304) includes a screw (3041).

8. A soft folding car cover according to claim 6, wherein the sliding bar (205) is provided with side grooves (2053), the side rail slider (207) includes a side rail baffle (2071) and a sliding bar insert (2073) connected to the side rail baffle (2071), the side rail baffle (2071) is provided with a socket (20711) and a threaded hole (20712) the sliding bar insert (2073) is provided in the side sliding groove (2053).

9. A soft folding car cover according to claim 7, wherein, the wrench sliding bar (302) is provided with a wrench sliding groove (3021), the wrench slider (305) is provided in the wrench sliding groove (3021), the wrench slider (3021) is provided with a cutout (3022), the wrench slider (305) is provided with a side channel (2036), the side channel (2036) is provided with a wrench semicircular catch (3051).

10. A soft folding car cover, wherein, it includes a longitudinal support structure and a transverse support structure connected to the longitudinal support structure.
The longitudinal support structure includes two side rail assemblies, each side rail assembly includes a plurality of side rails (9), two adjacent side rails (9) are connected to each other by a first rotating shaft joint assembly (6), a second rotating shaft joint assembly (7) or a third rotating shaft joint assembly (8).
The transverse support structure includes a front bar (1), a rear bar (5) and an intermediate support member, the intermediate support member is provided between the front bar (1) and the rear bar (5), the intermediate support member includes one or a combination of a front bar fixing system (2), a lock bolt fixing system (11) and an intermediate support member, the intermediate support member is connected to the longitudinal support structure.

11. A soft folding car cover according to claim 10, wherein, the front bar (1), the rear bar (5) and the intermediate support member are all provided on the upper side of the guide rail (10).
The car cover is connected to the guide rail (10) through a front bar extension plate (1002), the guide rail (10) is connected to the car body through a guide rail clamp (1001).
The threaded rod (2013) is connected to the front bar fixing block slider (203) through the front bar extension plate (1002).

12. A soft folding car cover according to claim 1, wherein the front bar (1), the front bar fixing system (2), the wrench fixing system (3), the intermediate fixing bar (4) and the rear bar (5) are of the same length.

13. A soft folding car cover according to claim 1, wherein, the front bar (1), the front bar fixing system (2), the wrench fixing system (3), the intermediate fixing bar (4) and the rear bar (5) are of the same width.

14. A soft folding car cover according to claim 3, wherein, the front bar (1), the front bar fixing system (2), the lock bolt fixing system (11), the intermediate fixing bar (4) and the rear bar (5) are of the same length.

15. A soft folding car cover according to claim 3, wherein, the front bar (1), the front bar fixing system (2), the lock bolt fixing system (11), the intermediate fixing bar (4) and the rear bar (5) are of the same width.

16. A soft folding car cover according to claim 1, wherein, the intermediate support member located at the front end is of a one-piece structure with the front bar (1), the intermediate support member located at the rear end is of a one-piece structure with the rear bar (5).
